(19) United States
(12) Patent Application Publication
(10) Pub. No.: US 2006/0272327 A1
(43) Pub. Date: Dec. 7, 2006

(54) Power tower

(75) Inventors: Nicholas Souris, Smyrna, GA (US); Lawrence Buice, Smyrna, GA (US)

Correspondence Address: Nicholas Souris, 331 Hurt Road S.W., Smyrna, GA, 30082, US

(73) Assignee: Souris Family Trust

(21) Appl. No.: 11/146,383

(22) Filed: Jun. 7, 2005

(51) Int. Cl. F03B 17/02; F03B 13/18

(52) U.S. Cl. 60/495; 60/504

(57) ABSTRACT

Means to use a water column in conjunction with a number of containers, being filled with air, when at the bottom of the column and thus forced to travel to the top of the water column, due to the buoyancy principle and said containers being attached to a motor chain or other means to control their perpetual travel in a sequential travel within the column of water in the process of rising to the top, thus causing energy suitable to be used. Then provide means to transfer said energy so produced by the rotating motor chain caused by the container's function, being forced to the top of the water column every time they are filled with air. By being able to maintain said operating conditions in said equipment at all times, a continuous energy is produced and so transferred through the chain and holding gears to a desired use.

### FIELD OF THE INVENTION

This invention relates to a water tower design capable to produce perpetual energy at an economical means, suitable for the industry and individual exploitation. A column of water such as a 100 feet or other height, allowing a container full of air to travel from the bottom of the column to the top, such travel will be accomplished since the water will force the container to the top of the column of water due to the principle of buoyancy, thus forcing the object to the surface of the water, floatation, caused by water displacement, causing back pressure and pushing the object in this case the container to the top of the water column. Thus producing a certain amount of energy, said energy if used appropriate can be hence exploited.

Assuming that a number of containers attached to a chain, such as motorcycle chain, secured on at least by two gears or rollers, allowing the chain to move within a loop travel, within the supporting gears and rollers if any, thus receiving and transferring the energy produced by the moving containers to the chain.

Consisting of the following main components:

1 Represents a tube of an appropriate length, width and size, said tube being open at top or sealed.
2 Represents a set of two gears at least to guide a motor chain to create a travel loop
3 Represent a chain, secured by means of gears, referred in item #2, in order to allow a certain loop travel, suitable for the operation required, and thus permit the containers attached to the chain to travel up and down the water column.
4 Represents a number of containers attached to said chain described in item #3 in such position as to allow air to enter into the container(s) when at the bottom of the water column, and force the cylinder(s) to float to the top of the water column, and when said container(s) reaches the top of the water column, the position of the container(s) is reversed, so the air will escape and allow the container(s) to fill with water, and sink down by gravity.
   Thus the chain when changing direction will cause the attached container leading upwards to be filled with air and rise and then change position again, leading downwards, thus allowing the air to escape and the container to fill with water, permitting the container to sink down and due to its weight to cause additional energy to be added to the chain.
   A consequential operation of the attached container(s) will cause the chain to rotate constantly thus producing energy. Said energy being transferred to the chain and through the gear(s) to a useful application.
   In lieu of using air to fill the container(s) an alternate substance, such as gas or liquid of lighter viscosity than water can be used, since said substances such as for example fuel oil, will rise to the top of the water column, thus also pushing the containers up to the surface. In such case the liquid substance can be dropped as overflow from the top of the tower, causing additional energy.

### OBJECT OF THE INVENTION

The primary object of this invention is to use a column of water, such a 100 feet or other height and permit a number of containers to rise up due to buoyancy caused by filling said containers with air and down by emptying the air from the container and allowing it to fill with water and sink down by gravity, said containers being attached to a chain, such as motorcycle chain, secured on at least by two gears, thus transferring the energy so produced by said chain, being rotated by the attached containers during their accent and descent in the column of water.

### SUMMARY OF THE INVENTION

A column of water of a desired size and shape to contain a number of containers attached to a motor chain or the alike, said chain revolving between at least two gears, positioning said containers, when they are at the bottom of the column, to have an open side of the container facing downwards, thus being capable to be filled with air, said air causing buoyancy of the container suitable to force said container to the top of the water column, and since said container(s) is being attached to the chain said chain will move accordingly, when the container reaches the top of the column said container will reverse its position, having the open side upwards, thus allowing the air to escape and fill instead with water, thus permitting the container to sink down by its gravity. Thus a compound force is applied to the chain and said force can be transferred via the chain holding gears to a useful energy conversion.

### Mode of Operation

A number of containers attached to a chain or similar in function, said chain immersed in a column of water and revolving between at least two gears or rollers, or a combination of both, positioning said containers, when they are at the bottom of the column, an open side of the container facing downwards, thus being capable of being filled with air, said air causing buoyancy of the container suitable to force said container to the top of the water column, when said container reaches the top of the water column the container is reversed in position, allowing the air to escape and instead be filled with water, thus permitting the container to sink by gravity, adding some additional force to the chain. Said container(s) are being attached to the chain, said chain will move accordingly within the loop of travel guided by the gears and transfer the energy so produced to the gears to be converted to a form of usable energy. By installing a number of such containers on said chain a continuous rotation of the chain can be produced. A continuous energy with lesser amount of energy input than output is therefore produced.

Said design described above consists off,

a a water tube,
b an air injector into the system to fill the container with air when at the bottom position of the water column, thus by pushing the water out, causing buoyancy, in order for the container to rise within a body of water,
c a chain capable or rotating within a loop travel, between at least to gears,
d a number of containers attached to said chain referred on ‘c’,
e gears used to allow the chain to circulate within a loop and thus transferring the energy so produced via the gear(s).

### THE DRAWINGS

The invention, both as to its arrangement and mode of operation, can be more fully understood from the following exposition, when it is considered in conjunction with the accompanying drawing in which:

FIG. 1 shows a graphic representation of the system by identifying the components involved and a detailed arrangement of the chain, with the containers attached to said chain, said chain allowed to rotate between at least two gears, thus transferring the compound energy so produced by the containers floating to the top of the water column and by sinking back down again, causing a continual process thus causing a continuous rotation of the chain. Other factors such as the height of the water column, the size of the containers, the air pressure used and other factors will control further the amount of energy produced by the containers.

FIG. 2 shows similar arrangement, using two liquids of different density such as water and petrol. Petrol being lighter than water is fed at the bottom of the column and it will rise to the top, thus moving the scoops and cause rotation to the conveyor.

### DESCRIPTION OF THE PREFERRED EMBODIMENTS

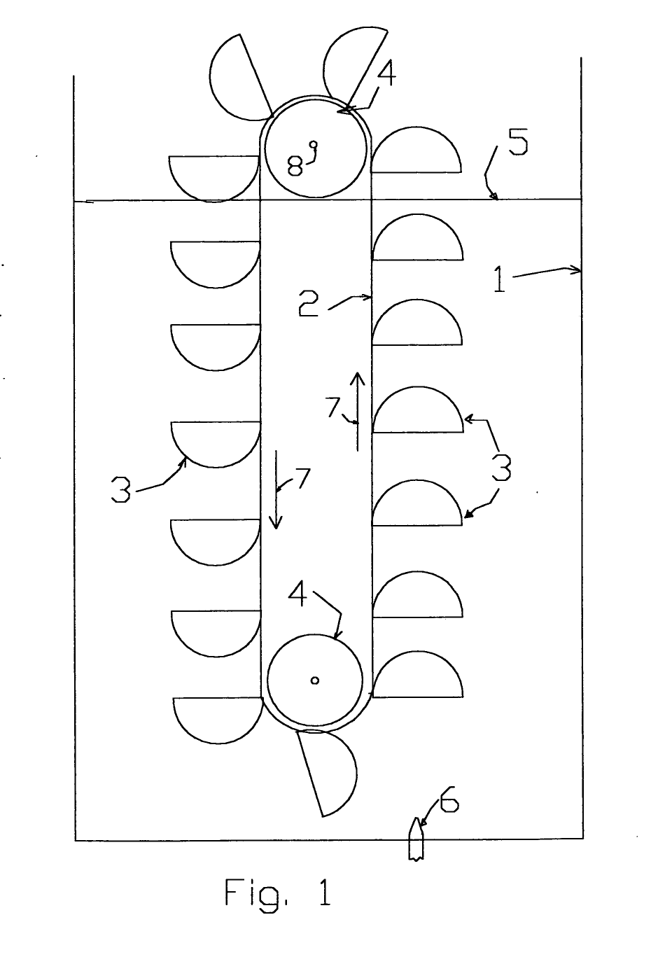

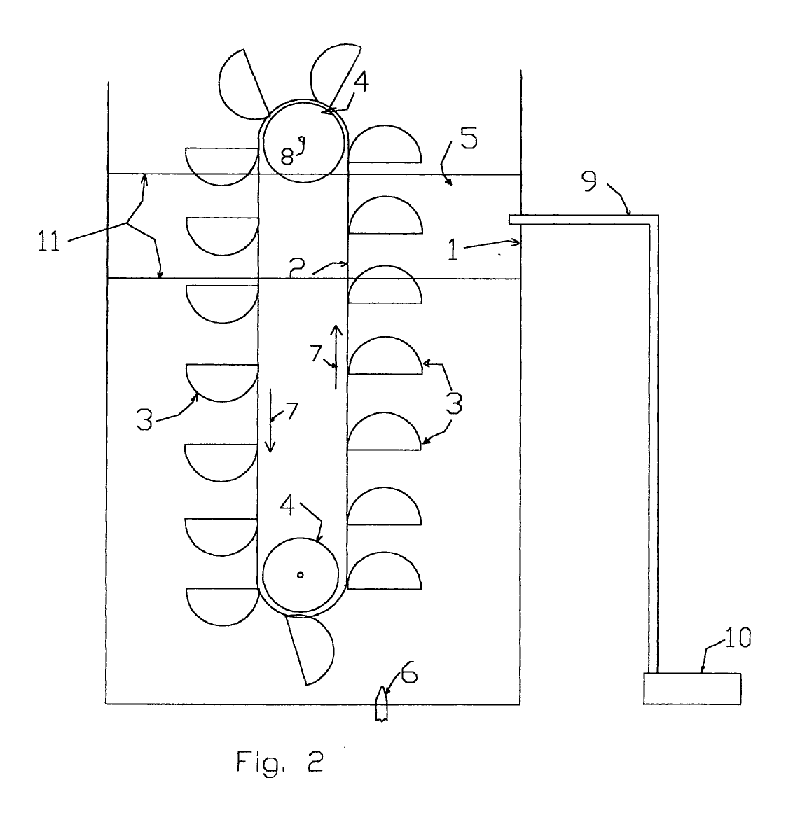

Referring now more particularly to the drawings, in which a preferred embodiment of the invention is illustrated in FIGS. 1 and 2 where:
1 Represents a tube of an appropriate length, width and size, said tube being open at top or sealed, said tube being filled with water as shown by item #5.
2 Represent a chain, within the water column referred to item #1, secured by means of gears item #4 to allow a certain loop travel, suitable for the operation required.
3 Represents a number of containers attached to said chain described in #2 in such position as to allow, when the container is at the bottom of the water column, air to enter into the container(s) and force the container(s) to float to the top of the water column. At that point the chain will change the direction of travel and the container will be leading downwards and reversed in position, thus allowing the air to escape and be filled with water, permitting the container to sink down and due to its weight to cause additional energy added to the chain.
4 Gears referred in item #2, where said gears being used to allow the travel of the chain within a specific loop of travel, will receive and transfer the energy so produced by the containers attached to said chain.
5 Represents the water level of the water column in the tube item #1.
6 Represents an air injector mounted on the water tube item #1, introducing air into the water column to fill the containers item # 3 with air, and thus rise to the surface. As mentioned before other liquid substance of lighter viscosity than water could be used to cause similar results.
7 Represents the conveyor
8 Represents the top pulley
9 Represents the overflow point
10 Represents a storage container for other distribution use
11 Represents the area were the lighter liquid will accumulate when it rises up due to the different viscosity.

### CONCLUSION, RAMIFICATIONS AND SCOPE

This invention provides means to use a column of water in conjunction with the appropriate equipment operating within the column of water to produce energy by means of forcing a number of containers to float from the bottom of the water column to the top, and being attached to a motor chain, running within a number of gears and thus circulating within a loop and hence producing a perpetual energy caused by the compound energy of the containers.

The amount of energy expanded to produce said energy consisting of injecting air or an alternate substance of gas or liquid of lighter viscosity, into the process to fill and force to lift the containers to the surface, said substance can be introduced by a pump added into the operating process.

Environmental impact: The environment stands to benefit since energy is produced without causing harm to the environment. Available water source is used to produce clean energy compared to others.

Efficiency: The use of a container(s) full of air in a column of water will force said container due to the principle of buoyancy to the surface of said column, said energy being transferred by means of chain having said containers attached to said chain and thus transferring the energy to the chain which in turn transfers the energy to the gears allowing the chain to rotate within a close loop travel

Conclusion: A container or a series of containers, in a column of water, when filled with air, the reaction of buoyancy principle will force said container(s) to rise to the surface of the water, thus producing a perpetual energy with lesser amount of energy input than output.

Reliability: Very few moving components are used in the design of this device.

a. a water tube,
b. an air injector into the system, or application of any other substance capable of rising within a body of water such as any liquid of lighter viscosity,
c. said air furnished to the injector(s) could be produced by an air pump, or in the case of other substance by the appropriate equipment,
d. a chain capable or rotating within a loop travel, between at least to gears and or rollers,
e. a number of containers attached to said chain referred on ‘d’,
f. gear(s) and or roller(s) used to allow the chain to circulate within a loop and thus receiving and transferring the energy so produced,
g. means to make up any water losses and maintain the water level as needed
h. an electric generator or any other desired device converting the produced energy
   All the above parts are of simple function, thus creating a better reliability.
   Economics: the savings so produced will offset the cost and maintenance of such a device.

1. A column of water of a desired size and shape to contain a number of containers attached to a chain or the alike, said chain revolving between at least two gears, positioning said containers, when they are at the bottom of the column, the open side of the container facing downwards, thus being capable to be filled with air, said air causing buoyancy of the container suitable to force said container to the top of the water column, and since being attached to the chain said chain will move accordingly and transfer the energy so produced to the gears to be used as needed, by installing a number of such container(s) on said chain a continuous rotation of the chain can be produced when said container(s) are filled with air, when they reach the bottom of the water column and the reaction of buoyancy principle will force said container(s) to rise to the surface of the water, thus producing a continuous energy with lesser amount of energy input than output said design described above consists off,
a a water tube,
b an air injector into the system to fill the container with air by pushing the water out, causing buoyancy, in order for the container to rise within a body of water,
c a motor chain capable of rotating within a loop travel, between at least to gears,
d a number of containers attached to said chain referred on ‘c’,
e a set of gears used to allow the chain to circulate within a loop and thus transferring the energy so produced.

2. A power tower design in claim 1, wherein an electric generator or any other desired device coupled to said gear(s) to receive and convert the produced energy to electricity.

3. A power tower design in claim 1, wherein the containers being filled with any other substance such as gas or liquid of lighter viscosity capable of rising within a body of water or other substance suitable for that purpose.

4. A power tower design in claim 1, wherein control means to drop said liquid substance used on claim #3 used to rise through the column of water to be dropped from the top of the tower by simple means of gravity to an energy receiving device, such as turbine and thus produce additional energy.
